(19) United States
(12) Patent Application Publication
(10) Pub. No.: US 2008/0150263 A1
(43) Pub. Date: Jun. 26, 2008

(54) Airbag apparatus

(75) Inventors: Yoshio Mizuno, Aichi-ken (JP); Takashi Ilda, Aichi-ken (JP); Shoichi Ibe, Aichi-ken (JP); Yasuhiro Katsuda, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-Ken (JP)

(21) Appl. No.: 12/004,497

(22) Filed: Dec. 21, 2007

(30) Foreign Application Priority Data
Dec. 26, 2006 (JP) 2006-349760

(51) Int. Cl. B60R 21/237; B60R 21/213

(52) U.S. Cl. 280/730.1

(57) ABSTRACT

An airbag apparatus of a vehicle is provided with an airbag deployed and inflated mainly in a portion of a passenger compartment of the vehicle rearward of a rear seat. Prior to deployment and inflation, the airbag has a bellows portion formed by folding a portion of the airbag near a gas inlet port into an accordion shape, and a roll portion formed by folding a portion of the airbag far from the gas inlet port into a roll shape, and is accommodated between a roof panel and a roof headlining of a vehicle in such a manner that the gas inlet port is positioned on a front side. Between the roof panel and the roof headlining, the bellows portion is arranged substantially above or substantially below the roll portion in such a manner that the flat sections are overlapped with each other substantially in a vertical direction.

### BACKGROUND OF THE INVENTION

The present invention relates to an airbag apparatus of a vehicle such as an automobile having an airbag deploying and inflating mainly in a portion of a passenger compartment rearward of a rear seat.

A typical example of this kind of airbag apparatus is disclosed, for example, in Japanese Laid-Open Patent Publication No. 2004-359209. The airbag apparatus in the publication is provided with an airbag having a gas inlet port. The airbag before being deployed and inflated has a bellows portion formed by folding a portion of the airbag close to the gas inlet port into an accordion shape, and a roll portion formed by folding a portion of the airbag far from the gas inlet port into a roll shape, and is accommodated between a roof panel and a roof headlining of the vehicle in such a manner that the gas inlet port is positioned on a front side. Between the roof panel and the roof headlining, the bellows portion is arranged in such a manner that the flat sections of the bellows portion are overlapped with each other in a longitudinal direction of the vehicle. Further, the bellows portion and the roll portion are arranged along the longitudinal direction of the vehicle.

When gas is supplied to the airbag folded as mentioned above, the bellows portion is first inflated. A substantially downward pressure is applied to the roof headlining on the basis of the inflation of the bellows portion, and the roof headlining is pivoted downward. As a result, an inclination of the roof headlining is increased. The roll portion gets out of a portion between the roof panel and the roof headlining while being unfolded by rolling on the roof headlining having an increased inclination, thereby getting. Thereafter, gas is further supplied, whereby the airbag is deployed and inflated mainly in a portion of the passenger compartment rearward of the rear seat.

As mentioned above, in the airbag apparatus in the publication, since the bellows portion of the airbag is arranged between the roof panel and the roof headlining in such a manner that the flat sections are overlapped with each other in the longitudinal direction of the vehicle. Since a base fabric sheet of the airbag is generally hard to be folded, it is necessary to arrange each adjacent pair of fold lines of the bellows portion in a shifted manner without aligning the adjacent fold lines in the longitudinal direction of the vehicle, to make a gap between the adjacent flat sections of the bellows portion small. However, in the case that the adjacent fold lines are arranged so as to be shifted in the longitudinal direction of the vehicle, the width of the bellows portion, that is, the size of the bellows portion in a vertical direction is increased. This increases a space necessary for accommodating the airbag.

### SUMMARY OF THE INVENTION

Accordingly, it is an objective of the present invention to provide an airbag apparatus, which can reduce a size in a vertical direction of an airbag in a folded state before being deployed and inflated and compactify a space necessary for accommodating the airbag.

To achieve the foregoing objective and in accordance with one aspect of the present invention, an airbag apparatus of a vehicle having an airbag deployed and inflated mainly in a portion of a passenger compartment of the vehicle rearward of a rear seat is provided. The airbag has a gas inlet port for introducing gas supplied to the airbag into the airbag for deploying and inflating the airbag. Prior to deployment and inflation, the airbag has a bellows portion having a plurality of flat sections formed by folding a portion of the airbag near the gas inlet port into an accordion shape, and a roll portion formed by folding a portion of the airbag far from the gas inlet port into a roll shape, and is accommodated between a roof panel and a roof headlining of the vehicle in such a manner that the gas inlet port is positioned on a front side.

The bellows portion is arranged substantially above or substantially below the roll portion in such a manner that the flat sections are overlapped with each other substantially in a vertical direction, between the roof panel and the roof headlining.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a side view of a rear portion of an automobile to which an airbag apparatus in accordance with a first embodiment of the present invention is applied;

FIG. 2 is a rear view of the automobile shown in FIG. 1;

FIG. 3 is a front view of the airbag in an unfolded state of the airbag apparatus in accordance with the first embodiment;

FIG. 4 is a cross-sectional view taken along line A-A in FIG. 2;

FIG. 5 is a cross-sectional view showing a state in which a bellows portion of the airbag shown in FIG. 4 is inflated;

FIG. 6 is a cross-sectional plan view of a rear portion of the vehicle shown in FIG. 1 at the time when the airbag is deployed and inflated;

FIG. 7 is a schematic diagram of a modification of the first embodiment;

FIG. 8 is a schematic diagram of an airbag apparatus in accordance with a second embodiment of the present invention;

FIG. 9 is a schematic diagram of the airbag apparatus shown in FIG. 8 and shows a state in which a bellows portion of an airbag is partly unfolded;

FIG. 10 is a schematic diagram of the airbag apparatus shown in FIG. 8 and shows a state immediately after supply of gas to the airbag is started;

FIG. 11 is a schematic diagram of an airbag apparatus in accordance with a third embodiment of the present invention; and

FIG. 12 is a schematic diagram of the airbag apparatus shown in FIG. 11 and shows a state immediately after supply of gas to the airbag is started.

### DETAILED DESCRIPTION OF THE PREFERRED EMBODIMENTS

### First Embodiment

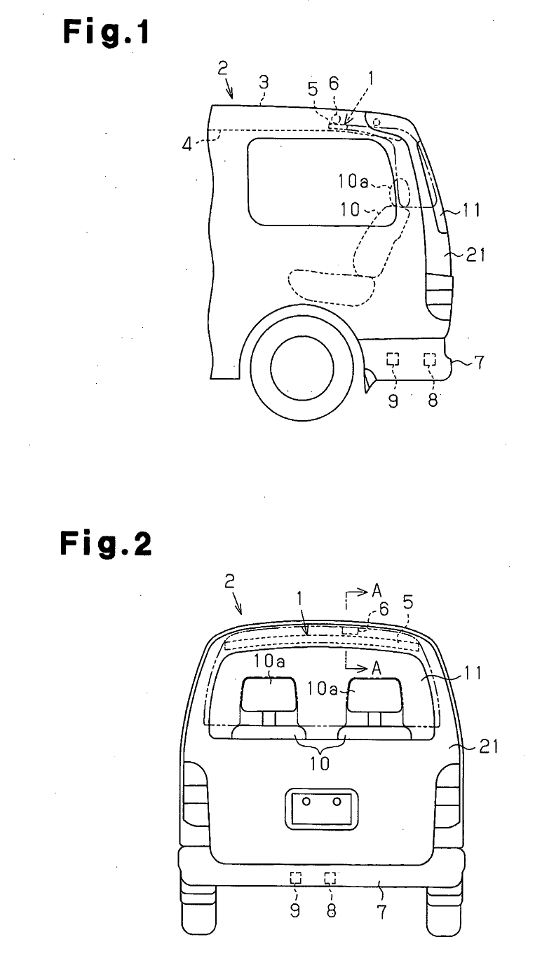

A first embodiment of the present invention will now be described with reference to FIGS. 1 to 6. As shown in FIGS. 1 and 2, an airbag apparatus 1 in accordance with the present embodiment is equipped and used in an automobile 2.

The airbag apparatus 1 is provided with an airbag 5 accommodated in a roof rear portion of the automobile 2 in a folded state. In the same manner, the roof rear portion is provided with an inflator 6 for supplying gas to the airbag 5. The inflator 6 is positioned forward of the airbag 5.

A sensor 8 that outputs a signal at the time when an impact equal to or greater than a predetermined level is applied to a rear portion of the automobile 2 is provided in the rear portion of the automobile 2, for example, in a rear bumper 7. Signals from the sensor 8 are input to a controller 9. The controller 9 outputs an operational signal to the inflator 6 in response to the input of the signal from the sensor 8. The inflator 6 starts supplying gas to the airbag 5 if it receives the operational signal from the controller 9. The airbag 5 is deployed and inflated mainly in a portion of a passenger compartment 19 rearward of a rear seat 10 by receiving the supply of gas from the inflator 6. A major part of the airbag 5 after being deployed and inflated is positioned between the rear seat 10 and a rear window 11, as shown by a two-dot chain line in FIGS. 1 and 2.

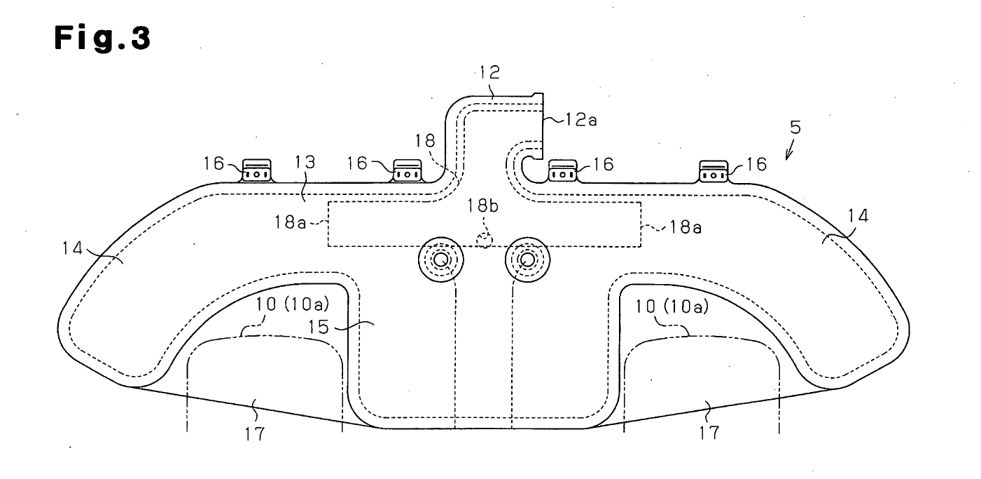

A description will be in detail given here of the airbag 5 with reference to FIG. 3.

A connection portion 12 connected to the inflator 6 is formed in an upper portion in FIG. 3 of the airbag 5. A gas inlet port 12a for introducing gas from the inflator 6 into the airbag 5 is formed in the connection portion 12. The connection portion 12 is connected to a lateral cell 13 in a portion in a downstream side of the gas inlet port 12a. The lateral cell 13 is deployed and inflated so as to extend in a width direction of the automobile 2 by receiving the supply of gas from the inflator 6. A plurality of attaching devices 16 used at the time of attaching the airbag 5 to the automobile 2 are fixed to an upper edge in FIG. 3 of the lateral cell 13. Vertical cells 14 are connected to both ends (both right and left ends in FIG. 3) of the lateral cell 13. Further, a vertical cell 15 is connected to a center of both ends of the lateral cell 13 (a center in a lateral direction in FIG. 3). Each of the right and left vertical cells 14 and the central vertical cell 15 is deployed and inflated so as to extend substantially downward by receiving the supply of gas from the inflator 6.

The airbag 5 is formed, for example, by sewing two base fabric sheets. The lateral cell 13 communicates with the connection portion 12, the right and left vertical cells 14, and the central vertical cell 15. The central vertical cell 15 is partitioned into three portions which are lined up laterally in FIG. 3. The three portions of the central vertical cell 15 all communicate with the lateral cell 13, however, do not directly communicate with the adjacent portions. A portion 17 of the airbag 5 positioned between the central vertical cell 15 and the left vertical cell 14, and a portion 17 of the airbag 5 positioned between the central vertical cell 15 and the right vertical cell 14 are not exposed to the supply of gas from the inflator 6.

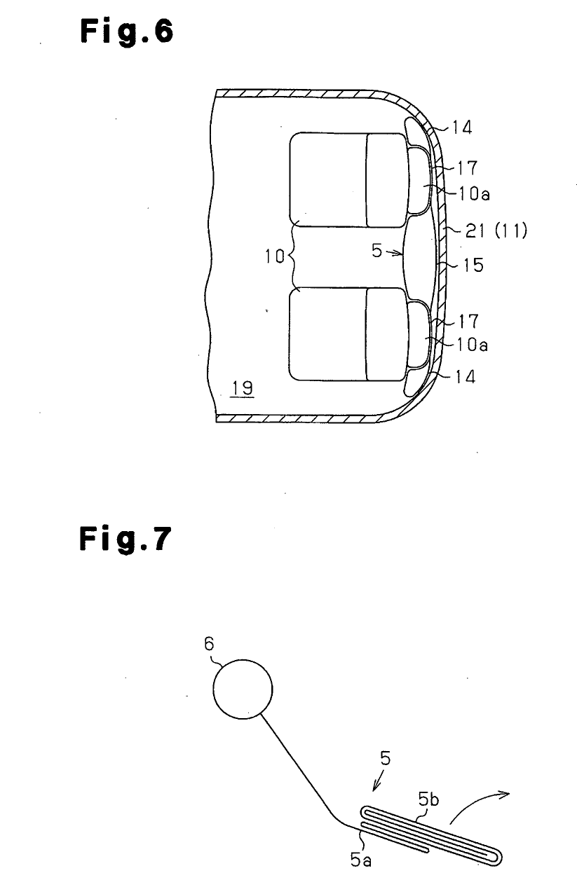

As shown in FIG. 6, in the airbag 5 in the deployed and inflated state, the central vertical cell 15 is positioned between headrests 10a of the rear seat 10, and the right and left vertical cells 14 are positioned outside of the respective corresponding headrests 10a in the width direction of the automobile 2. Further, the portion 17 of the airbag 5 between the central vertical cell 15 and the left vertical cell 14, and the portion 17 of the airbag 5 between the central vertical cell 15 and the right vertical cell 14 are respectively positioned rearward of the corresponding headrests 10a, that is, between the corresponding headrests 10a and the rear window 11. Accordingly, a forward movement of the vertical cells 14 and 15 is restricted.

An inner tube 18 for distributing gas from the inflator 6 to the right and left vertical cells 14 and the central vertical cell 15 is provided in inner portions of the connection portion 12 and the lateral cell 13 of the airbag 5. The inner tube 18 is formed by an elastic material, and can be folded together with the airbag 5. the folded inner tube 18 is unfolded together with the airbag 5 at the time of deploying and inflating the airbag 5.

A portion of the inner tube 18 positioned within the connection portion 12 has an opening corresponding to the gas inlet port 12a. A portion of the inner tube 18 positioned within the lateral cell 13 extends along an extending direction of the lateral cell 13, and openings 18a facing the right and left vertical cells 14 are formed in both ends thereof. Further, an opening 18b facing the central vertical cell 15 is formed in a center of both ends in the portion of the inner tube 18 positioned within the lateral cell 13. Accordingly, gas from the inflator 6 supplied into the airbag 5 passes through an inside of the inner tube 18, flows into the right and left vertical cells 14 from the right and left openings 18a, and flows into the central vertical cell 15 from the central opening 18b.

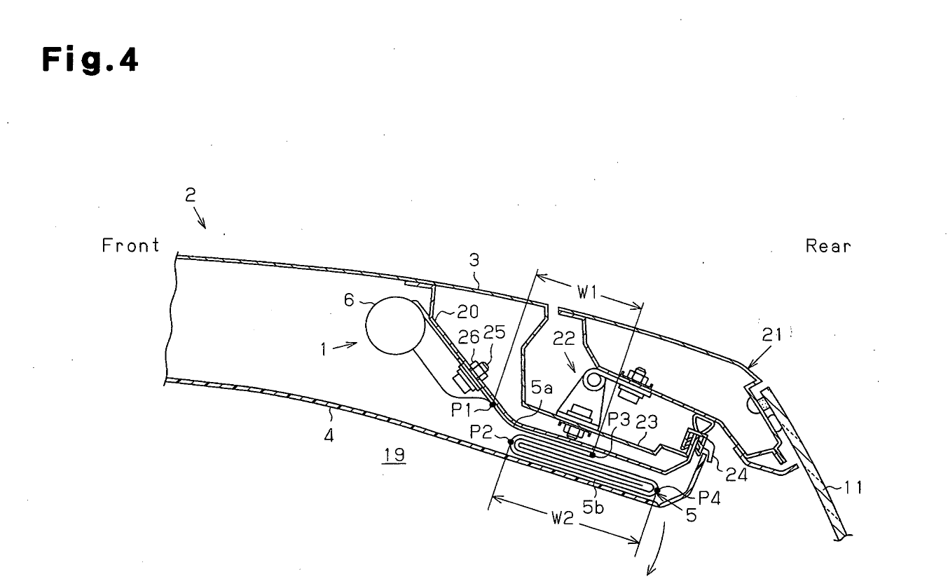

Next, a description will be given of a structure of a portion of the automobile 2 to which the airbag 5 is attached and the peripheral portion with reference to FIG. 4.

As shown in FIG. 4, which is a drawing of the roof rear portion of the automobile 2, the entire surface of the roof panel 3 facing the passenger compartment 19 is covered with the roof headlining 4 made of a flexible material. An inner panel 20 fixed to the roof panel 3 is provided between the roof panel 3 and the roof headlining 4. A rear end portion (a right end portion in FIG. 4) of the roof panel 3 is bent in such a manner as to come close to the inner panel 20 so as to be connected to a rear end of the inner panel 20, and serves as a rear roof rail 23 for supporting a rear hatch 21. The rear hatch 21 is pivotably attached to a rear end portion of the roof panel 3, that is, the rear roof rail 23 by a hinge mechanism 22. The rear window 11 is provided in the rear hatch 21.

The roof headlining 4 is attached to the roof panel 3 so as to be pivotable downward around a position on a front side (a left side in FIG. 4) in the automobile 2 than a position of the inner panel 20 fixed to the roof panel 3, that is, a front end of the roof headlining 4. A rear end of the roof headlining 4 is engaged with a locking piece 24 provided in a rear end of the rear roof rail 23 (or the roof panel 3 or the inner panel 20). The engagement between the rear end of the roof headlining 4 and the locking piece 24 is cancelled by a pressure in a substantially downward direction being applied to the roof headlining 4.

The airbag 5 and the inflator 6 are accommodated in a portion lower than the inner panel 20 and between the roof panel 3 and the roof headlining 4. The airbag 5 is arranged rearward of the inflator 6. The inner panel 20 is formed so as to have a high rigidity in such a manner as to be hard to be deformed even if an impact from the rear side is applied to the automobile 2, and the airbag 5 and the inflator 6 are attached to the inner panel 20. The attachment of the airbag 5 to the inner panel 20 is achieved by fixing the attaching devices 16 provided in the airbag 5 to the inner panel 20 by using bolts 25 and nuts 26.

A description will be in detail given below of the airbag 5 in the folded state in which the airbag 5 is accommodated between the roof panel 3 and the roof headlining 4, more specifically between the inner panel 20 and the roof headlining 4.

A portion of the airbag 5 close to the gas inlet port 12a is folded into an accordion shape, and a portion of the airbag 5 far from the gas inlet port 12a is folded into a roll shape. As shown in FIG. 4, the portion which is folded as the accordion shape and is close to the gas inlet port 12a forms a bellows portion 5a, and the portion which is folded as the roll shape and is far from the gas inlet port 12a forms a roll portion 5b. The bellows portion 5a is formed by folding the portion at a fold line set in such a manner as to extend across the portion close to the gas inlet port 12a in the airbag 5. Accordingly, the number of flat sections (pleats) included in the bellows portion 5a is two. Gas tends to flow in the bellows portion 5a in comparison with the roll portion 5b because of the different folding ways. The roll portion 5b is unfolded by rolling on the inclined roof headlining 4 at the time when the roof headlining 4 is pivoted downward.

As is clear from FIG. 4, in the airbag 5 accommodated in the folded state between the roof panel 3 and the roof headlining 4, the bellows portion 5a and the roll portion 5b are arranged so as to be lined up in an substantially vertical direction. More specifically, the bellows portion 5a is arranged substantially above the roll portion 5b. Further, the bellows portion 5a is arranged in such a manner that the flat sections of the bellows portion 5a are overlapped with each other in the substantially vertical direction. The roll portion 5b is preferably formed as a flat shape in order to reduce the dimension in the substantially vertical direction small.

The dimension of the bellows portion 5a in the longitudinal direction of the automobile 2, that is, a width W1 of the bellows portion 5a is smaller than the dimension of the roll portion 5b in the longitudinal direction of the automobile 2, that is, a width W2 of the roll portion 5b. A rear end P3 of the bellows portion 5a is positioned forward of a rear end P4 of the roll portion 5b. A front end P2 of the roll portion 5b is positioned rearward of a front end P1 of the bellows portion 5a.

The airbag 5 accommodated in the folded state as mentioned above is deployed and inflated in accordance with the following procedure.

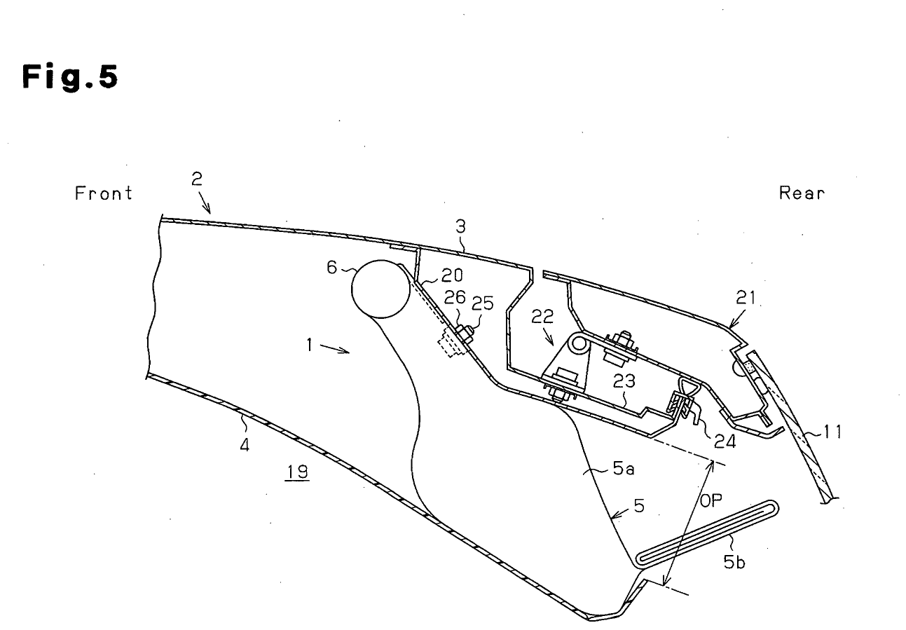

If gas is supplied to the airbag 5 in the folded state from the inflator 6, the bellows portion 5a of the airbag 5 is first inflated. A substantially downward pressure is applied to the roof headlining 4 on the basis of an inflation of the bellows portion 5a. Accordingly, the engagement between the rear end of the roof headlining 4 and the locking piece 24 is canceled, and the roof headlining 4 is pivoted downward around the front end of the roof headlining 4, as shown by an arrow in FIG. 4. As a result, as shown in FIG. 5, the inclination of the roof headlining 4 is increased. The roll portion 5b of the airbag 5 gets out from the portion between the roof panel 3 and the roof headlining 4 while being unfolded by rolling on the roof headlining 4 having the increased inclination. Thereafter, gas from the inflator 6 is further supplied, whereby the airbag 5 is deployed and inflated in the portion of the passenger compartment 19 rearward of the rear seat 10, as shown in FIG. 6.

As the roof headlining 4 is pivoted downward in accordance with the inflation of the bellows portion 5a, an interval OP (refer to FIG. 5) between the rear end of the roof headlining 4 and the inner panel 20 becomes large. The larger the width W1 of the bellows portion 5a is set, the larger a volumetric capacity of the bellows portion 5a at the time of inflating becomes, so that a pivoting amount of the roof headlining 4 caused by the inflation of the bellows portion 5a is increased. In other words, the larger the width W1 of the bellows portion 5a is set, the larger the amount by which the roof headlining 4 comes away from the roof panel 3 becomes on the basis of the inflation of the bellows portion 5a. In the case of the present embodiment, the width W1 of the bellows portion 5a is set such that the roof headlining 4 comes away from the roof panel 3 on the basis of the inflation of the bellows portion 5a, at a necessary and sufficient magnitude for allowing the roll portion to be unfolded.

In accordance with the present embodiment described in detail above, the following advantages are obtained.

(1) In the airbag 5 accommodated in the folded state between the roof panel 3 and the roof headlining 4, the bellows portion 5a is arranged in such a manner that the flat sections of the bellows portion 5a are overlapped with each other in the substantially vertical direction. Accordingly, even if the width W1 of the bellows portion 5a is set large for sufficiently securing the volumetric capacity of the bellows 5a at the time of inflating, there is no risk that the size in the vertical direction of the airbag 5 in the folded state is increased. By contrast, as the number of the flat sections of the bellows portion 5a is increased, the size in the vertical direction of the airbag 5 in the folded state is increased. However, since it is sufficiently possible to secure the volumetric capacity of the bellows portion 5a at the time of inflating by setting the width W1 of the bellows portion 5a large, it is not always necessary to set the number of the flat sections of the bellows portion 5a at a large level for securing the volumetric capacity of the bellows portion 5a at the time of inflating. In other words, in order to secure the volumetric capacity of the bellows portion 5a at the time of inflating, there is no risk that the size in the vertical direction of the airbag 5 is increased. Accordingly, it is possible to compactify the space necessary for accommodating the airbag 5 in the folded state.

(2) In the airbag 5 accommodated in the folded state between the roof panel 3 and the roof headlining 4, the bellows portion 5a is arranged substantially above the roll portion 5b. Thus, there is no risk that the weight of the roll portion 5b is applied to the bellows portion 5a. This is advantageous for smoothly proceeding with the inflation of the bellows portion 5a at the time when gas from the inflator 6 is supplied to the airbag 5.

(3) The bellows portion 5a is formed by folding the portion near the gas inlet port 12a in the airbag 5 at a single fold line extending across the same portion, and the number of the flat sections of the bellows portion 5a overlapped with each other is two, or the minimum number. Accordingly, it is possible to minimize a size increase that the bellows portion 5a causes to the vertical direction size of the airbag 5 in the folded state.

(4) As the roof headlining 4 is pivoted downward in accordance with the inflation of the bellows portion 5a, the position of the airbag 5 on the roof headlining 4, particularly the position of the roll portion 5b is moved downward and forward. If the moving amount to the downward direction and the forward direction of the airbag 5 is too large, it may become difficult for the airbag 5 to be deployed and inflated in the portion of the passenger compartment 19 rearward of the rear seat 10. In the case that the width W1 of the bellows portion 5a is set too large, the volumetric capacity of the bellows portion 5a at the time of inflating becomes excessively large. Accordingly, there is a risk that such a matter occurs. However, in the case of the present embodiment, the width W1 of the bellows portion 5a is set smaller than the width W2 of the roll portion 5b. In other words, the width W1 of the bellows portion 5a is relatively small. Making further reference thereto, the width W1 of the bellows portion 5a is set such that the roof headlining 4 is pivoted by the inflation of the bellows portion 5a at a necessary and sufficient magnitude for allowing the unfolding of the roll portion. Accordingly, the risk that the matter as mentioned above occurs is small.

(5) In the airbag 5 accommodated in the folded state between the roof panel 3 and the roof headlining 4, the front end P2 of the roll portion 5b is positioned rearward of the front end P1 of the bellows portion 5a. As mentioned above, the roll portion 5b is positioned rearward in comparison with the bellows portion 5a. In other words, the roll portion 5b is arranged relatively in a rear portion. This is advantageous for more reliably deploying and inflating the airbag 5 in the portion of the passenger compartment 19 rearward the rear seat 10.

The present embodiment may be modified, for example, as follows.

In the airbag 5 accommodated in the folded state between the roof panel 3 and the roof headlining 4, the front end P2 of the roll portion 5b may be positioned forward of the front end P1 of the bellows portion 5a. Alternatively, the positions in the longitudinal direction of the front end P2 of the roll portion 5b and the front end P1 of the bellows portion 5a may be identical. Further, the rear end P3 of the bellows portion 5a may be positioned rearward of the rear end P4 of the roll portion 5b, or the positions in the longitudinal direction of the rear end P3 of the bellows portion 5a and the rear end P4 of the roll portion 5b may be identical.

The width W1 of the bellows portion 5a may be appropriately changed. For example, the width W1 of the bellows portion 5a may be identical with the width W2 of the roll portion 5b, or may be set larger than the width W2 of the roll portion 5b.

The bellows portion 5a may be formed by folding the portion near the gas inlet port 12a in the airbag 5 at a plurality of (preferably three or more odd number of) fold lines extending across the same portion. In this case, the number of the flat sections of the bellows portions 5a overlapped with each other is three or more.

In the airbag 5 accommodated in the folded state between the roof panel 3 and the roof headlining 4, the bellows portion 5a may be arranged substantially below the roll portion 5b, as shown in FIG. 7. In this case, the bellows portion 5a is first inflated at the time when gas from the inflator 6 is supplied to the airbag 5, whereby the position of the roll portion 5b is moved upward and rearward as shown by an arrow in FIG. 7. This is advantageous for more reliably deploying and inflating the airbag 5 in the portion of the passenger compartment 19 rearward of the rear seat 10.

The positions, the magnitudes, and the shapes of the cells 13, 14 and 15 of the airbag 5 may be appropriately changed.

### Second Embodiment

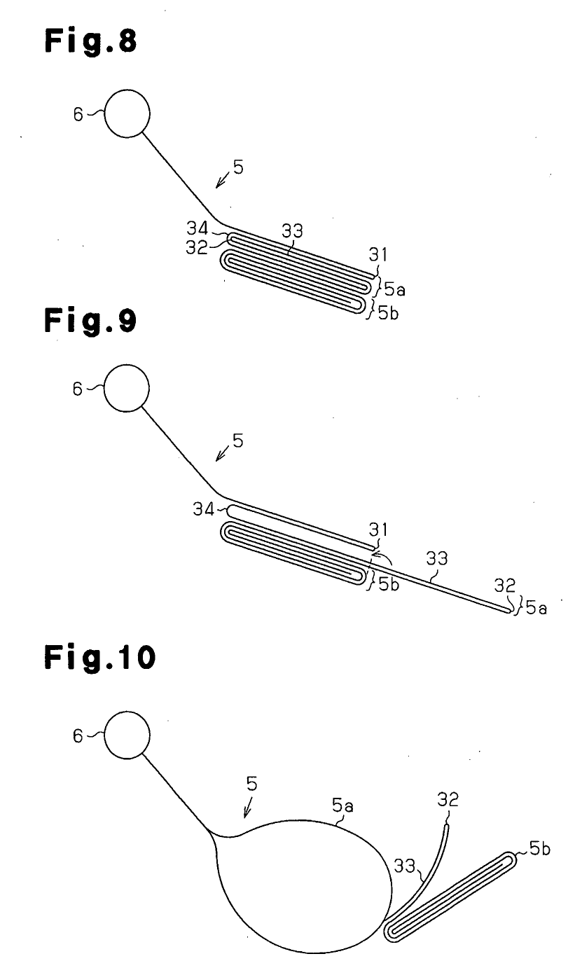

Next, a second embodiment of the present invention will now be described with reference to FIGS. 8 to 10. An airbag apparatus in accordance with the second embodiment is different from the first embodiment in the structure of the bellows portion 5a of the airbag 5.

As shown in FIG. 8, in the second embodiment, the bellows portion 5a of the airbag 5 in the folded state is arranged substantially above the roll portion 5b, in the same manner as the first embodiment. Further, the bellows portion 5a is arranged in such a manner that the flat sections of the bellows portion 5a are overlapped with each other in the substantially vertical direction.

As is apparent from FIGS. 8 and 9, the portion of the airbag 5 near the gas inlet port is first folded into an accordion shape at three fold lines 31, 34 and 32 extending across the same portion, at the time of forming the bellows portion 5a. Three fold lines 31, 34 and 32 are lined up in such a manner that the distance from the gas inlet port increases in this order. The interval between the fold line 34 and the fold line 32 is about double the interval between the fold line 31 and the fold line 34. Accordingly, a portion 33 including the fold line 32 protrudes rearward, in an intermediate folded body of the bellows portion 5a shown in FIG. 9 and obtained by being folded at the fold lines 31, 34 and 32. The protruding portion 33 is thereafter folded back upward at a fold line (set in an intersecting portion to a chain line in FIG. 9) set between the fold line 34 and the fold line 32, and is arranged between two flat sections of the bellows portion 5a partitioned by the fold line 34.

If gas from the inflator 6 is supplied to the airbag 5 having the bellows portion 5a formed as mentioned above, the bellows portion 5a is first inflated. When the folding back of the portion 33 is unfolded as shown in FIG. 10, in the process that the bellows portion 5a is inflated, the roll portion 5b is pushed rearward in conjunction with the unfolding. Accordingly, the deployment and inflation of the roll portion 5b are started in a further rearward position.

In accordance with the second embodiment, in addition to the advantages (1) and (2) in the first embodiment, the following advantages are obtained.

As described above, the roll portion 5b is pushed rearward in conjunction with the unfolding of the folding back of the protruding portion 33 in the process that the bellows portion 5a is inflated. Accordingly, the deployment and inflation of the roll portion 5b are started in a further rearward position. This is advantageous for more reliably deploying and inflating the airbag 5 in the portion of the passenger compartment 19 rearward of the rear seat 10.

The second embodiment may be modified, for example, as follows.

In the airbag 5 in the folded state, the positions in the longitudinal direction of the front end of the bellows portion 5a and the front end of the roll portion 5b need not always be identical as shown in FIG. 8, but may be different. For example, in the case that the front end of the roll portion 5b is arranged rearward of the front end of the bellows portion 5a, it is possible to obtain the same advantage as the advantage (5) in the first embodiment.

Further, the positions in the longitudinal direction of the rear end of the bellows portion 5a and the rear end of the roll portion 5b need not always be identical as sown in FIG. 8, but may be different.

The dimension of the bellows portion 5a in the longitudinal direction of the automobile, that is, the width of the bellows portion 5a need not always be identical with the dimension of the roll portion 5b in the longitudinal direction of the automobile, that is, the width of the roll portion 5b as shown in FIG. 8, but may be larger or smaller.

The number of the fold lines included in the bellows portion 5a may be more than the number exemplified above.

The interval between the fold line 34 and the fold line 32 may be smaller than about double the interval between the fold line 31 and the fold line 34. In this case, the fold line 32 is not positioned close to the fold line 34 as shown in FIG. 8, but is positioned away from the fold line 34, at the time of folding back the protruding portion 33 in the intermediate folded body of the bellows portion 5a.

The folding back of the protruding portion 33 in the intermediate folded body of the bellows portion 5a may be carried out so as to be arranged above two flat sections of the bellows portion 5a partitioned by the fold line 31, in place of being arranged between two flat sections partitioned by the fold line 34. Alternatively, it may be carried out so as to be arranged below two flat sections partitioned by the fold line 34.

In the airbag 5 in the folded state, the bellows portion 5a may be arranged substantially below the roll portion 5b.

### Third Embodiment

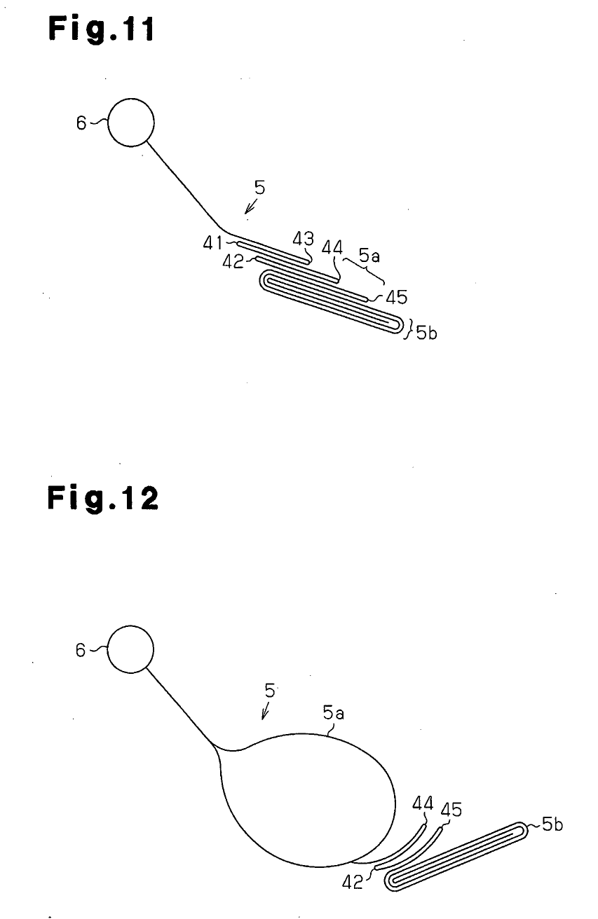

Next, a third embodiment of the present invention will now be described with reference to FIGS. 11 and 12. An airbag apparatus in accordance with the third embodiment is different from the first embodiment in the structure of the bellows portion 5a of the airbag 5.

As shown in FIG. 11, in the third embodiment, the bellows portion 5a of the airbag 5 in the folded state is arranged substantially above the roll portion 5b, in the same manner as the first embodiment. Further, the bellows portion 5a is arranged in such a manner that the flat sections of the bellows portion 5a are overlapped with each other in the substantially vertical direction.

The bellows portion 5a is formed by folding the portion of the airbag 5 near the gas inlet port into an accordion shape in a plurality of (five in the present embodiment) fold lines 41, 42, 43, 44 and 45 extending across the same portion. A pair of adjacent flat sections of the bellows portion 5a are respectively arranged in such a manner that the upper flat section (more accurately, the flat section on an upstream side (the portion closer to the gas inlet port) in the airbag 5) is positioned forward of the lower flat section (more accurately, the flat section on downstream side (the portion farther from the gas inlet port) of the airbag 5). In other words, with regard to the fold lines 41 and 42 existing forward of the bellows portion 5a, the fold line 41 positioned on an upstream side in the airbag 5 is arranged forward of the fold line 42 positioned on a downstream side in the airbag 5. With regard to the fold lines 43, 44 and 45 existing rearward of the bellows portion 5a, it is preferable that the fold line positioned in the more upstream side of the airbag 5 is arranged forward.

If gas from the inflator 6 is supplied to the airbag 5 having the bellows portion 5a formed as mentioned above, the bellows portion 5a is first inflated. The roll portion 5b is pushed rearward as shown in FIG. 12, in the process that the bellows portion 5a is inflated. Accordingly, the deployment and inflation of the roll portion 5b are started in a further rearward position.

In accordance with the third embodiment, the advantages shown below are obtained in addition to the advantages (1) and (2) in the first embodiment.

As described above, the roll portion 5b is pushed rearward in the process that the bellows portion 5a is deployed and inflated. Accordingly, the deployment and inflation of the roll portion 5b are started in a further rearward position. This is advantageous for more reliably deploying and inflating the airbag 5 in a portion of the passenger compartment 19 rearward of the rear seat 10.

The third embodiment may be modified, for example, as follows.

In the airbag 5 in the folded state, the bellows portion 5a need not always be positioned forward of the roll portion 5b as shown in FIG. 11, but may be positioned rearward of the roll portion 5b, or the positions in the longitudinal direction of the bellows portion 5a and the roll portion 5b may be identical. In the case of arranging the front end of the roll portion 5b rearward of the front end of the bellows portion 5a, more accurately, in the case of arranging the front end of the roll portion 5b rearward of the fold line 42 positioned in the most downstream side of the airbag 5 in the fold lines 41 and 42 existing forward of the bellows portion 5a, the same advantage as the advantage (5) in the first embodiment is obtained.

The positions in the longitudinal direction of the rear end of the bellows portion 5a and the rear end of the roll portion 5b may be identical with each other or different from each other.

The dimension of the bellows portion 5a in the longitudinal direction of the automobile, that is, the width of the bellows portion 5a may be identical with the dimension of the roll portion 5b in the longitudinal direction of the automobile, that is, the width of the roll portion 5b. Alternatively, the width of the bellows portion 5a may be larger or smaller than the width of the roll portion 5b.

The number of the fold lines included in the bellows portion 5a may be appropriately changed.

In the airbag 5 in the folded state, the bellows portion 5a may be arranged substantially below the roll portion 5b.

1. An airbag apparatus of a vehicle, comprising an airbag deployed and inflated mainly in a portion of a passenger compartment of the vehicle rearward of a rear seat, the airbag having a gas inlet port for introducing gas supplied to the airbag for deploying and inflating the airbag, wherein, prior to deployment and inflation, the airbag has a bellows portion having a plurality of flat sections formed by folding a portion of the airbag near the gas inlet port into an accordion shape, and a roll portion formed by folding a portion of the airbag far from the gas inlet port into a roll shape, and is accommodated between a roof panel and a roof headlining of the vehicle in such a manner that the gas inlet port is positioned on a front side, and wherein the bellows portion is arranged substantially above or substantially below the roll portion in such a manner that the flat sections are overlapped with each other substantially in a vertical direction, between the roof panel and the roof headlining.

2. The airbag apparatus according to claim 1, wherein the bellows portion is arranged above the roll portion.

3. The airbag apparatus according to claim 1, wherein the bellows portion is arranged below the roll portion.

4. The airbag apparatus according to claim 1, wherein the bellows portion is formed by folding a portion of the airbag near the gas inlet port at a single fold line.

5. The airbag apparatus according to claim 1, wherein a dimension of the bellows portion in a longitudinal direction of the vehicle is smaller than a dimension of the roll portion in the longitudinal direction of the vehicle.

6. The airbag apparatus according to claim 5, wherein the dimension of the bellows portion in the longitudinal direction of the vehicle is set such that the roof headlining is moved away from the roof panel on the basis of the inflation of the bellows portion at a necessary and sufficient magnitude for allowing the roll portion to be unfolded.

7. The airbag apparatus according to claim 1, wherein the front end of the roll portion is arranged rearward of the front end of the bellows portion.

8. The airbag apparatus according to claim 1, wherein, at the time of forming the bellows portion, an intermediate folded body is first formed by folding the portion of the airbag near the gas inlet port into an accordion shape at a plurality of fold lines, wherein a portion including one of the fold lines protrudes rearward in the intermediate folded body, and wherein the protruding portion is thereafter folded back.

9. The airbag apparatus according to claim 8, wherein the bellows portion is arranged above the roll portion, and the protruding portion in the intermediate folded body is folded back upward.

10. The airbag apparatus according to claim 1, wherein, in a pair of adjacent flat sections of the bellows portion, the flat section located on an upstream side in the airbag is positioned forward of the flat section located on a downstream side in the airbag.
